(19) United States
(12) Patent Application Publication
(10) Pub. No.: US 2020/0193384 A1
(43) Pub. Date: Jun. 18, 2020

(54) METHOD FOR EVALUATING EMPLOYMENT CANDIDATES USING A COMPETENCY SCORE

(71) Applicant: Stephanie Cecchini, Cottonwood Heights, UT (US)

(72) Inventor: Stephanie Cecchini, Cottonwood Heights, UT (US)

(21) Appl. No.: 16/690,024

(22) Filed: Nov. 20, 2019

Related U.S. Application Data
(60) Provisional application No. 62/780,766, filed on Dec. 17, 2018.

(51) Int. Cl. G06Q 10/10; G06Q 10/06; G06F 16/9535; G06N 5/04

(52) U.S. Cl. CPC G06Q 10/1053; G06N 5/04; G06F 16/9535; G06Q 10/06393

(57) ABSTRACT

A method of ranking potential candidates for employment opportunities with improved accuracy may feature the cognitive diversity of highly relevant and crowd sourced data. It is surer than other methods because it uses a mathematical algorithm with that data to create a number that can be used at-a-glance to rank workers' competencies, predict the risk of a hiring mistake, and to compare job candidates.

### CROSS-REFERENCES TO RELATED APPLICATIONS

This Application claims priority as a perfection of prior filed U.S. Provisional Application No. 62/780,766, filed on Nov. 28, 2018, and incorporates the same by reference herein in its entirety.

### FIELD OF THE INVENTION

The present invention relates to the field of predictive algorithms and more particularly relates to an algorithm that generates a competency score for applicants for a position in an effort to predict successful integration and performance of the applicant once hired.

### BACKGROUND OF THE INVENTION

Recruiting is time-consuming and expensive. It requires hunting for candidates, often administering pre-employment tests, and conducting screening interviews. Skill certification exams, education in a theory-based environment (i.e. schools), and years of seat-time experience in a job do not always help recruiters to find the best candidates for a job. Candidates who look good on a resume or online job board sometimes misrepresent themselves. Candidates with training and no experience struggle to prove their value in advance of the hire. Candidates who are experts have no way to stand out to recruiters who vet so many resumes they begin to all look the same. There is no at-a-glance method to understand and compare candidates' real-world competency or the risk of a hiring mistake.

Currently, finding the best candidates requires recruiters to ask for a minimum number of years' experience, professional certification, or education. With rapidly evolving needs for new skills, recruiters struggle with this method, and candidates with new skills have no method to demonstrate their competency in advance of the hire.

This invention relies on the cognitive diversity of highly relevant and crowd sourced data. It is surer than other methods because it uses a mathematical algorithm with that data to create a number, or score, that can we used at-a-glance to compare candidates and to reduce the risk of a hiring mistake. The present invention represents a departure from the prior art in that the methodology of the present invention allows for a more direct comparison of potential candidates for a position with verifiable real-world experience rather than self-reported credentials.

### SUMMARY OF THE INVENTION

In view of the foregoing disadvantages inherent in the known types of candidate evaluation methods, an improved evaluation methodology may provide a crowdsourced ranking system that meets the following objectives: it creates a vibrant online community form which to crowdsource data, is anonymous with its data collection, and provides relevant information for hiring decisions.

Unlike other methods, the crowdsourced multi-perspective data points data to rank the competency of employees or prospective employees with Competency Scores using a mathematical algorithm that dynamically updates with new qualifying events. It uses an online community that ranks and connects members while allowing them to initially remain anonymous. This helps employers to avoid accidental bias at risk with the EEOC. This helps employees and prospective employees to compare skills, salary requirements, and other data points with their peers. The ranked community also allows peers to seek mentor or mentee relationships. The method of the present invention also relies primarily on voluntarily data provided by employers and their representatives, and by the employee or prospective employee, with their full consent and knowledge.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a flow chart depicting use of an embodiment of the invention to obtain a competency score for an individual on behalf of an employer or school.

FIG. 2 is a flow chart depicting use of an embodiment of the invention to obtain a competency score of an individual on his/her behalf.

FIG. 3 is a flow chart depicting use of an embodiment of the invention whereby an individual's competency score is updated with an employer or school's input.

FIG. 4 is a flow chart depicting an embodiment of the invention whereby an individual's competency score is updated with a qualifying event.

### DETAILED DESCRIPTION OF THE PREFERRED EMBODIMENT

With reference now to the drawings, a preferred embodiment of the competency score methodology is herein described. It should be noted that the articles “a”, “an”, and “the”, as used in this specification, include plural referents unless the content clearly dictates otherwise.

The method requires the existence of an online or other community dedicated to the furthering of the industry in question. This community should include, at least, individuals who work in the industry, employers who hire in the industry, and educators who train in the industry. As these people interact, all will build a reputation within the community and data from these interactions not only are used to compute a Competency Score, but also verify the data and may even help define what data is relevant.

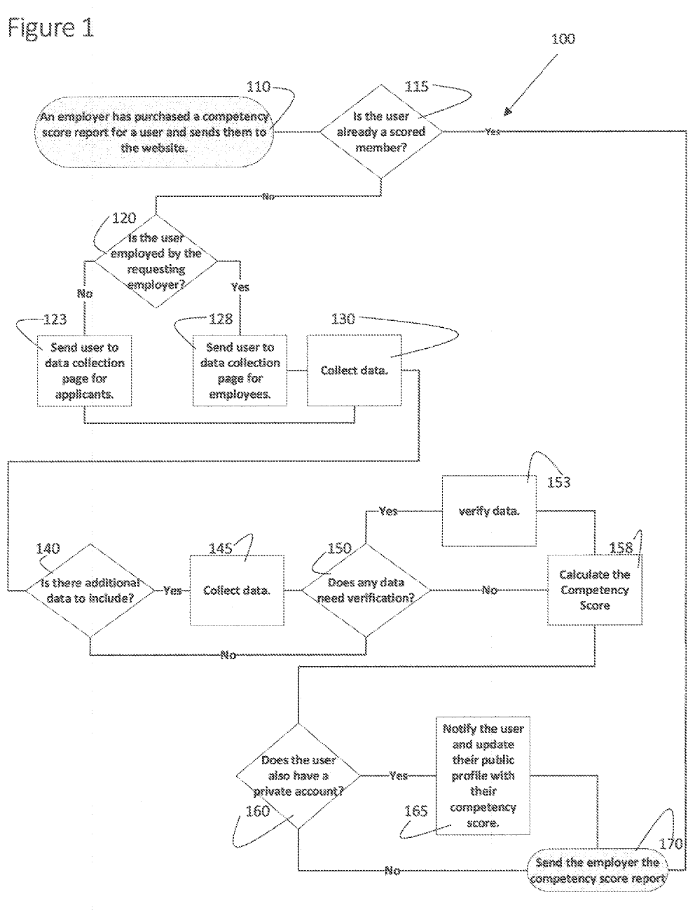

The method has four major components corresponding to four major scenarios, illustrated in FIGS. 1-4. With reference to FIG. 1, a method of providing a competency score to an employer or school (together considered an “employer” for purposes of this application) 100 includes several data collection 130, 145 and data verification 153 steps. As the method is based on utilizing crowd sourced and other available data to obtain a score, such data must be collected and verified to provide an accurate score. In the depicted scenario, an employer requests an individual to obtain a certification score 110. Assuming the individual is not already a member of the provided online community, one of two data collection pages 123, 128 are offered, depending on whether the individual is already an employee or an applicant 120. Initial data is then collected from the pages 130. At this point, additional data can be mined 140, from references or self-reported other projects. If any exists, it may also be collected 145. Verification may then occur as needed 150 and may be accomplished though other community contacts or from outside the community 155. A competency score may then be generated 158 which may then be provided to the user (if the user is a member 165) and the employer 170.

The competency score may be generated from providing a weighted score to various verifiable education aspects, skills, and accomplishments within and outside the community. The table below provides an example of such accomplishments and weighted scores as might be applied to medical coders.

TABLE 1

| | | | | | | Conversion to |
|---|---|---|---|---|---|---|
| Component | | Component | Actual | Min | Max | Component |
| Categories | Input | Value | Points | Required | Allowed | Point |
| Volume of | Verified Experience: | 5% | 1 | NA | 2 | 60 |
| Work | 12 months full time | | | | | |
| Experience | within the last 24 | | | | | |
| | months | | | | | |
| Volume of | Verified Experience: | 10% | 6 | NA | 5 | 88 |
| Work | More than 3 years | | | | | |
| Experience | | | | | | |
| Recent and | Verified Training: 1 | 10% | 1 | NA | 1 | 15 |
| Relevant | medical coding | | | | | |
| Education | certification | | | | | |
| Recent and | Verified Training: | 2% | 0 | 2 | 3 | 0 |
| Relevant | More than 1 medical | | | | | |
| Education | coding certification | | | | | |
| Recent and | Verified Training: | 2% | 0 | 3 | 5 | 0 |
| Relevant | More than 3 medical | | | | | |
| Education | coding certifications | | | | | |
| Recent and | Verified Training: | 1% | 0 | NA | 1 | 0 |
| Relevant | Post-Secondary | | | | | |
| Education | Career Course | | | | | |
| Recent and | Verified Training: | 1% | 2 | NA | 2 | |
| Relevant | Associate Degree | | | | | |
| Education | | | | | | |
| Recent and | Verified Training: | 2% | 0 | NA | 5 | 0 |
| Relevant | Bachelor's Degree | | | | | |
| Education | | | | | | |
| Recent and | Verified Training: | 1% | 0 | NA | 3 | 0 |
| Relevant | Master's Degree | | | | | |
| Education | | | | | | |
| Recent and | Verified Training: | 1% | 0 | NA | 4 | 0 |
| Relevant | Doctorate Degree | | | | | |
| Education | | | | | | |
| Employer | Employer | 15% | 3 | NA | 5 | 100 |
| Satisfaction | Satisfaction (None | | | | | |
| | Default to 3) | | | | | |
| Verified Real | Skills Assessment: | 10% | 96 | 95 | 100 | 82 |
| World | Medical coding | | | | | |
| Competency | speed | | | | | |
| Verified Real | Skills Assessment: | 10% | 99 | 95 | 100 | 89 |
| World | Medical coding | | | | | |
| Competency | accuracy | | | | | |
| Verified Real | Skills Assessment: | 10% | 16 | 15 | 25 | 94 |
| World | Technology (EMR, | | | | | |
| Competency | CRM, Documents, | | | | | |
| | Spreadsheets) | | | | | |
| Verified Real | Skills Assessment: | 10% | 18 | 10 | 20 | 88 |
| World | Communication | | | | | |
| Competency | Skills | | | | | |
| Verified Real | Skills Assessment: | 10% | 96 | 95 | 100 | 82 |
| World | Medical coding | | | | | |
| Competency | speed | | | | | |
| Verified Real | Skills Assessment: | 10% | 99 | 95 | 100 | 89 |
| World | Medical coding | | | | | |
| Competency | accuracy | | | | | |
| Verified Real | Skills Assessment: | 10% | 16 | 15 | 25 | 94 |
| World | Technology (EMR, | | | | | |
| Competency | CRM, Documents, | | | | | |
| | Spreadsheets) | | | | | |
| Verified Real | Skills Assessment: | 10% | 18 | 10 | 20 | 88 |
| World | Communication | | | | | |
| Competency | Skills | | | | | |
| Verified Real | Skills Assessment: | 10% | 17 | 15 | 20 | 75 |
| World | Billing Skills | | | | | |
| Competency | (Reimbursement | | | | | |
| | types, payor | | | | | |
| | specific guidelines) | | | | | |
| Verified Real | Personality and | 5% | 15 | 10 | 20 | 15 |
| World | aptitude assessment | | | | | |
| Competency | | | | | | |
| Verified Real | Skills Assessment: | 10% | 17 | 15 | 20 | 75 |
| World | Billing Skills | | | | | |
| Competency | (Reimbursement | | | | | |
| | types, payor | | | | | |
| | specific guidelines) | | | | | |
| Verified Real | Personality and | 5% | 15 | 10 | 20 | 15 |
| World | aptitude assessment | | | | | |
| Competency | | | | | | |
| Community | Willingness to free | 3% | 5 | NA | 5 | |
| Involvement | intern (if less than | | | | | |
| | 12 months | | | | | |
| | experience) | | | | | |
| Community | Community | 3% | 5 | NA | 25 | |
| Involvement | Involvement: | | | | | |
| | Teaching and | | | | | |
| | mentoring | | | | | |
| Conduct | Verified: NOT on | 100% | 0 | NA | 0 | 0 |
| | OIG or other | | | | | |
| | Federal Exclusion | | | | | |
| | | | | | SCORE | 706 |

As can be seen in the table, information may be divided into six main categories: Volume of Experience, Recent and Relevant Education, Employer Satisfaction, Verified Real World Competency, Community Involvement, and Professional Conduct. Certain categories, such as Volume of Experience and Recent and Relevant Education, are rather easy to measure, as they merely takes a report of what an individual has done, usually self-reported on the member's profile, and verification that they have done it. Verification may be by other community members or by member submitted verification, such as a transcript. In the Table, Experience in the field is further broken down into a base level of desirable experience (for instance, 12 months in the last 24 of full-time employment or equivalent) and advanced years (with a suggested threshold of three years for the separation). The components here may be weighted so that very experienced individuals do not overwhelm lesser experienced and newer individuals in the field. What is actually relevant experience may be dependent upon not only the industry, but also the community itself, and there may be more categories of experience which may or may not be relevant (e.g. separate categories for 1-3 years of experience, 3-6 years of experience, 6+ years, and less than 1). Education data is also relatively easy to acquire and verify and may include degrees and other continued training. Any educator in the community could then verify that a candidate did, in fact, complete a given degree program. Continued training may also be easily verified and may be particularly cogent or necessary for continued licensing (e.g. CLE credits for attorneys).

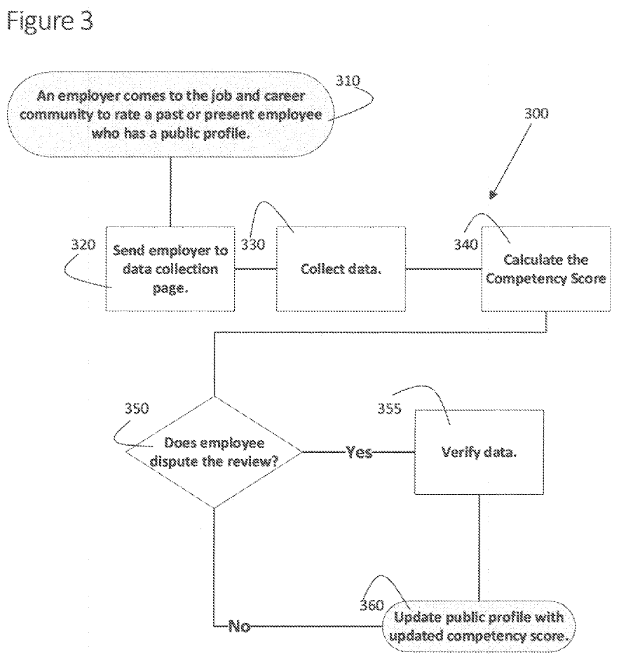

The other categories may also be collected from interaction with the community. Employer satisfaction may be collected as feedback or reviews from employers concerning job performance (See FIG. 3), with a default value for no or very few reviews. Adding a default value avoids unduly penalizing those just starting out in the industry and gives them a chance to compete. Verification of Competency may be verified by administering skills tests or collecting feedback from others. These tests could be administered by a third party, perhaps one with some form of oversight or recognition in the field, or by the community itself. Note that for some industries, this category may not be relevant or easily administered. Community involvement may also provide an objective evaluation of the candidate's experience as they are seen in the community. Anything that the community provides may then be used as community involvement. In the sample table, willingness to intern and providing support to others in the form of mentoring are considered as viable contributions to a Competency Score. Finally, if professional responsibility can be tracked, having meritorious or improper reported conduct may then also affect the Competency Score. Other industries may have other standards by which to measure competency, it should be understood that these particular categories may be relevant to many fields, but by no means create an exhaustive list or does the method require all six to be present.

Each category and type of information is given a relative weight and a scoring paradigm. For instance, a bachelor's degree may be given a certain weight, as it could be the gateway to the profession, but more advanced degrees may be given less additional weight as a reflection of 1. the time and acquired skills necessary to obtain an advanced degree should be reflected; but, 2. such weight may be only an incremental improvement over a bachelor's degree. Foundational degrees may also be given less weight for some professions as their universal requirement makes their useful weight in creating a score meaningless. Various assessments of skill may be given weight depending on reputation in the field. Greater or less weight may be given to feedback contributed by third parties like employers or other community members as opposed to industry experience. Some fields require certain degrees, such as medical or legal degrees, and as such may require a minimum education level to even join (such as at least be enrolled in an accredited degree program if the community wants to provide opportunity for internships). Each industry could have its own specific mix of categories and relevant information within those categories to generate a base score for an individual.

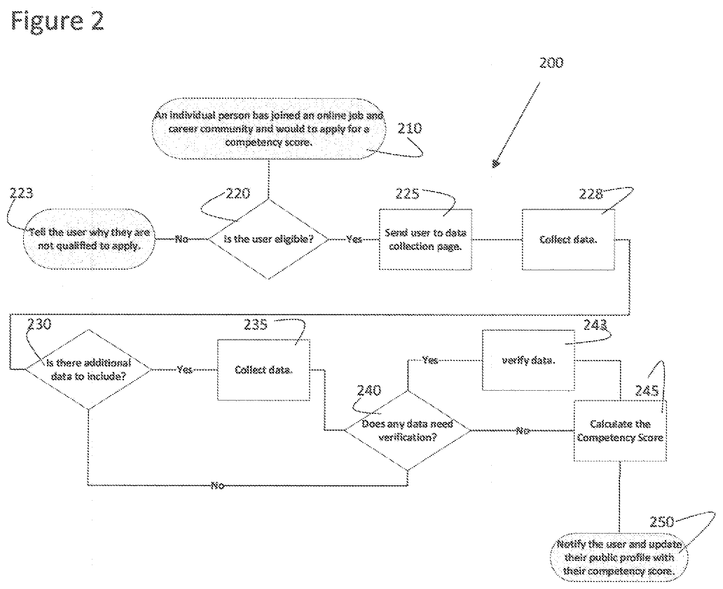

Individual users may opt to join the online community on their own initiative and obtain a competency score (FIG. 2) 200. After an application is filed 210, a determination as to eligibility is made 220. Eligibility thresholds would be dependent upon the online community. For instance, if the community is for attorneys, having a bar membership or being enrolled in a law school could be eligibility qualifications. If the user is not eligible, they can be told as such 223. Once eligibility is verified, the user could then be directed to a general data collection page 225 where data is collected 228, additional data may then be included 230 and collected 235 and all of the data which can be verified 240 goes through a verification process 243. The competence score is then computed as described above 240 and reported to the user and added to the new user profile 250.

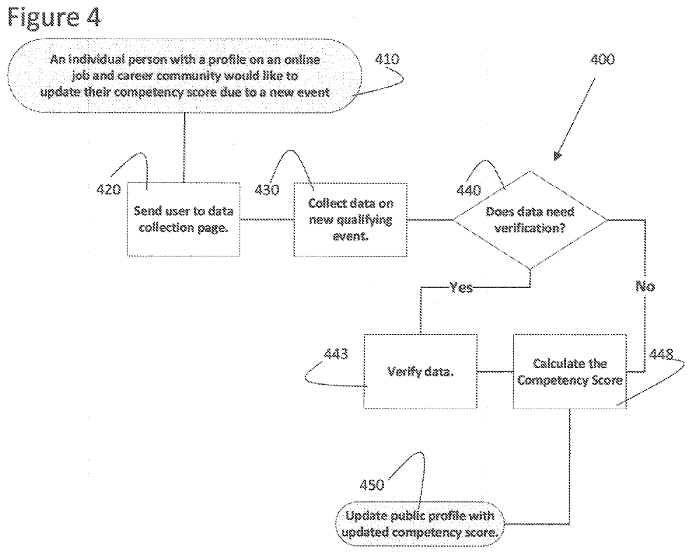

Updating a Competency Score may be done by employer and educator reviews 300 (FIG. 3) or by the reporting of qualifying events 400 (FIG. 4). In the first case, the employer or educator is already a member of the community and has either hired the individual for a particular job or has participated in the individual's education 310. The employer logs onto the community and is sent to a data collection page 320, from which data is collected 330. The data may include a base rating (such as a number from 1-5, or other rating systems) and a description of what was done and the employer's impressions of the individual. The Competency Score may then be updated. If the review is not positive, the individual may be given the opportunity to dispute the review after posting and the Competency Score updated 350. If possible, this data could then be verified 355. A new Competency Score could then be posted 360 for the individual either as a result of the further investigation into the dispute or just provisionally while the dispute is being investigated. Qualifying events (FIG. 4) could be added by the individual logging into the community 410 and providing data on a collection page 410 for collection 430 and verification if possible 440. Once verified 443, the new Competency Score may be calculated 448 and posted 450. It should also be noted that employers and educators may also receive rankings according to Competency Scores as provided in this method. While the qualifying data points may be different than with individuals, they should be relevant in the field for educating and employing. Such criteria could include educators who have published in the field, percentage of graduates with jobs, average experience of faculty, and other criteria for educators and employee satisfaction reviews, number of tasked hired out to the community, and other reputational qualifications for employers.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A method of evaluating employment candidates, the method comprising:
a. a first step of providing an online community of members in a given industry, said community including members representing educational entities, employment entities, and individuals who work in the industry;
b. a second step of allowing all members to complete a public community profile;
c. a third step of gathering information from the public community profile regarding members;
d. a fourth step of allowing members to validate information provided on the public community profile; and
e. compiling a competency score based upon information gathered and, where appropriate, validated from the public community profile and assigning said competency score to a given member.

2. The method of claim 1, the information gathered from the public community profile being at least one type of information selected from the set of types of information consisting of: education information and work experience.

3. The method of claim 1, further comprising a step of allowing employment entity members to submit reviews of individual members and using information from the reviews as a component in the compilation of the competency score.

4. The method of evaluating employment candidates of claim 1, further comprising a step of providing opportunity for members to participate in the community and using said participation as a in the compilation of the competency score.

5. The method of evaluating employment candidates of claim 1, further comprising a step of administering at least one competency test to at least one individual member and utilizing scores from said at least one test as at least one component in the compilation of the competency score.

6. The method of claim 1, further comprising a step of collecting competency test information regarding individual members from third parties and utilizing said competency test information as a component in the compilation of the competency score.

7. The method of evaluating employment candidates of claim 1, further comprising a step of verifying professional conduct information and using said professional conduct information as a component in the compilation of the competency score.
